(19) United States
(12) Patent Application Publication
(10) Pub. No.: US 2006/0265939 A1
(43) Pub. Date: Nov. 30, 2006

(54) Device for affixing attachments to a fishing line

(75) Inventor: Roger Friedrichs, Brazoria, TX (US)

Correspondence Address: William D. Wiese;DuBois, Bryant, Campbell & Schwartz, LLP, Suite 1300, 700 Lavaca Street, Austin, TX, 78701, US

(73) Assignee: QuickSwirl, LLC

(21) Appl. No.: 11/226,400

(22) Filed: Sep. 14, 2005

Related U.S. Application Data
(60) Provisional application No. 60/684,342, filed on May 25, 2005.

(51) Int. Cl. A01K 91/04

(52) U.S. Cl. 43/44.83; 43/43.1

(57) ABSTRACT

A method and device for affixing an attachment to a fishing line are disclosed. The device is generally configured with an eye at the distal end of a wire shank and an open loop at the proximal end of the shank. However, rather than terminating the loop at the proximal end of the shank by wrapping the proximal end of the wire tightly around the shaft, the wire is loosely wrapped around the shank so as to permit an attachment to fit over the end of the wire and slide easily around the shank until the attachment is removeably positioned within the loop at the proximal end of the shank.

### PRIORITY STATEMENT UNDER 35 U.S.C. § 119 & 37 C.F.R. § 1.78

This non-provisional application claims priority based upon prior U.S. Provisional Patent Application Ser. No. 60/684,342 filed May 25, 2005 in the name of Roger Friedrichs, entitled “Device for Attaching Fishing Lure to a Line,” the disclosure of which is incorporated herein by reference.

### TECHNICAL FIELD OF THE INVENTION

The present invention relates generally to fishing equipment. More specifically, the present invention relates to an improved method and device for attaching a fishing hook, lure or accessory to the end of a fishing line.

### BACKGROUND OF THE INVENTION

There are a number of known methods and devices for affixing an attachment to the end of a fishing line. For purposes of this application, an attachment includes such devices as any type or size of hook, a body of any size, shape or color, with one or more hooks attached thereto, an additional length of fishing line, or any other device or apparatus that may be used or useful in catching fish.

During fishing, it is frequently desired to change attachments so as to change the presentation of the attachment to the fish or to alter the size, shape, color or design of the attachment. This may be necessary due to a change in environmental conditions such as the weather or time of day or the type of fish sought. It is often important to disconnect the existing attachment from the fishing line and connect the new attachment quickly and easily, so that fishing may be resumed as soon as possible.

Typically, fishing attachments are affixed to the end of a fishing line by inserting the fishing line through a hole, also known as an “eye”, in the attachment, or a loop attached to the attachment, and tying the line thereto. In such cases, the fishing line must be cut in order to remove the attachment from the line. Cutting the existing attachment from the fishing line and tying the line to a new attachment is a very time consuming process and requires a great deal of manual dexterity to manipulate the relatively small diameter fishing line. Fishing is often conducted under adverse weather conditions and a fisherman may be wearing bulky clothing and even gloves, thus making it difficult to tie a knot in the line. Consequently, cutting the line to replace an attachment is slow and tedious.

In order to eliminate the need for cutting the line, a “leader” is sometimes attached to the fishing line. A leader is a relatively short (typically 6 to 18 inches in length) piece of fishing line or metal wire. The fishing line is tied to one end of the leader. The other end of the leader typically includes a clip to which attachments may be affixed. Many different attachments may be affixed to the clip without cutting the fishing line. However, a leader represents an additional expense to the fisherman and still requires that the leader be tied to the fishing line. Further, under the aforementioned adverse weather conditions, it is still difficult and time consuming to open or close the clip on the end of the leader. Moreover, a leader with a clip affixed thereto is inefficient and difficult to use under actual fishing conditions. For example, a leader is considered inefficient because the line strength of a conventional fishing line is severely reduced if formed into a knot. The knot creates a weak point in the line and increases the possibility of a broken line when a fish is caught on the attachment.

The need remains, therefore, for a simple but durable method for affixing an attachment to a fishing line.

### SUMMARY OF THE INVENTION

The present invention provides an improved method and device for affixing an attachment to a fishing line. The device is generally configured with an eye at the distal end of a wire shank and an open loop at the proximal end of the shank. However, rather than terminating the loop at the proximal end of the shank by wrapping the proximal end of the wire tightly around the shaft, the wire is loosely wrapped around the shank so as to permit an attachment to fit over the end of the wire and slide easily around the shank until the attachment is removeably positioned within the loop at the proximal end of the shank.

This invention, together with the additional features and advantages thereof will become more apparent to those of skill in the art upon reading the description of the preferred embodiments, with reference to the following drawings.

### DESCRIPTION OF THE DRAWINGS

A better understanding of the system and method of the present invention may be had by reference to the drawing figures, wherein:

FIG. 1 is a side view of one embodiment of the device of the present invention affixed to a fishing line;

FIG. 2 is a side view of one embodiment of the device of the present invention with a hook being affixed to the device;

FIG. 3 is a side view of one embodiment of the device of the present invention with a hook affixed to the device;

FIG. 4 is an alternative embodiment of the device of the present invention with a round proximal loop;

FIG. 5 is an alternative embodiment of the device of the present invention with a triangular proximal loop;

FIG. 6 is an alternative embodiment of the device of the present invention with a square proximal loop;

FIG. 7 is an alternative embodiment of the device of the present invention with a trapezoidal proximal loop; and

FIG. 8 is an alternative embodiment of the device of the present invention with the wire end used to form the proximal loop making a single pass around the shank.

### DESCRIPTION OF THE PREFERRED EMBODIMENTS

The present invention is an improved method and device for affixing attachments to a fishing line. It should be appreciated that the present invention is equally applicable to attaching any type of fishing accessory to any type of line used in connection therewith. The fishing accessory may be any type of tackle, accessory, or, if the case of flyfishing, fly or device appurtenant thereto. It should also be appreciated that, although the material used to make the device of the present invention is described as a wire herein, it may be any material with the ductility to be formed into the configurations described herein and the strength to adequately affix the line to the attachment during use. It should also be appreciated that the line to which the device of the present invention is attached may be made of any material such as, for example, a flexible monofilament, but that the type of line to which the device is attached is not a part of this invention and, therefore, not a limitation thereof.

Referring now to the various figures of the drawing wherein like reference characters refer to like parts throughout the several views. FIG. 1 shows one embodiment of the device 100 of the present invention. The device 100 has a distal end 102, a proximal end 104, and a shank 106 that is generally aligned longitudinally between the distal end 102 and the proximal end 104. At the distal end 102 of the device 100, the wire used to form the device 100 is formed into a loop 108 and then the end of the wire is wrapped around the shank 106 to close the loop 108, thus forming an eye through which a fishing line 110 may be tied or otherwise attached. The loop 108 may be in the form of a ball eye, looped eye, tapered eye, oval eye or other configuration commonly known in the art.

At the proximal end 104 of the device 100, a loop 112 is formed and the end of the wire is again wrapped around the shank 106 to close the loop 112 however, in this instance, the wire is wrapped loosely around the shank 106 so as to leave a gap between the wrapped wire and the shank 106. This gap must be large enough to accommodate the eye of an attachment that the user may wish to attach to the device 100. An attachment includes such devices as one or more of any type or size of hook, a body of any size, shape or color, with one or more hooks attached thereto, an additional length of fishing line, a weight, a flotation device, or any other device or apparatus that may be used or useful in catching fish. The wire may be any size but is preferably between 19/0 gauge and 32 gauge.

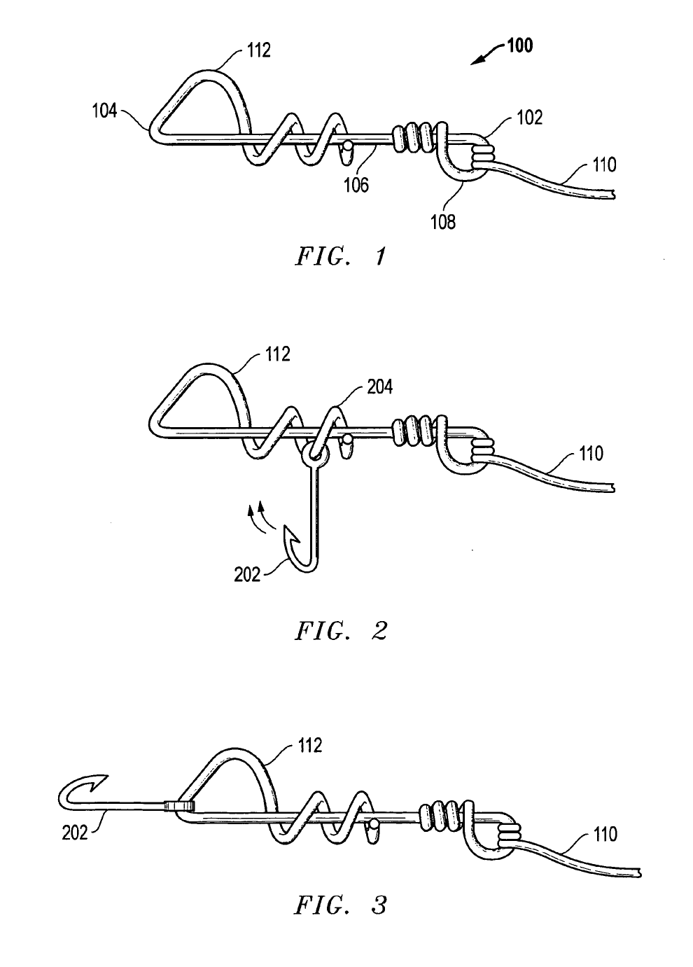

FIG. 2 shows a hook 202 that is being attached to the device 100. The eye of the hook 202 has been fit over the end of the wire 204 used to for the device 100. Thereafter, the hook 202 is passed along the wire and around the shank 106 until such time as the hook 202 is positioned in the loop 112 at the proximal end of the device 100 as shown in FIG. 3. The hook 202 may be removed from the loop 112 by passing the hook 202 along the wire around the shank 106 in the reverse direction until such time as the eye of the hook 202 passes the end of the wire 204.

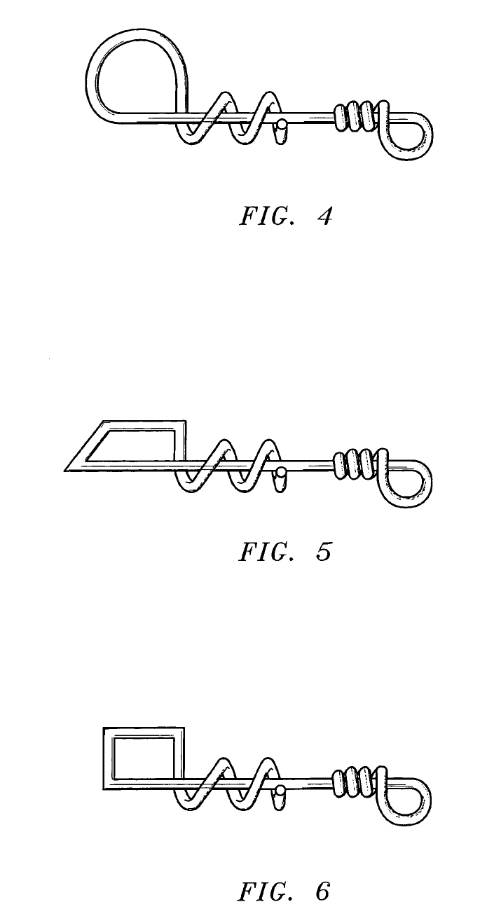

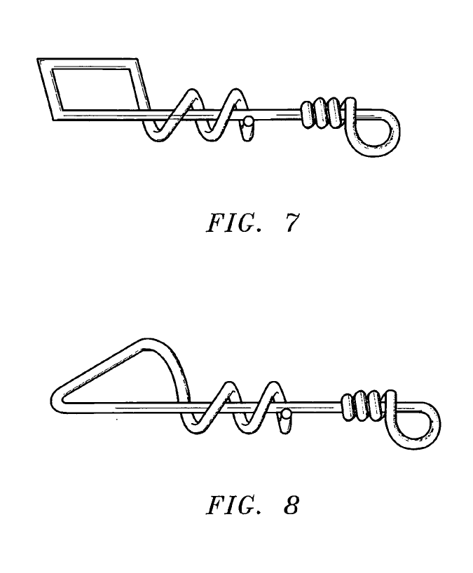

FIG. 4, FIG. 5, FIG. 6 and FIG. 7 show alternative configurations for the loop 112 at the proximal end of the device 100. There may be many different configurations and designs for the loop 112 that may be used or useful in affixing an attachment to the device 100, or in facilitating the use of the attachment once it has been attached to the device 100. For example, FIG. 4 shows the loop 112 in a generally circular configuration, thereby allowing a hook or other attachment to move freely around loop 112 without being biased into any single position. Alternatively, the loop 112 in FIG. 5 is configured to bias an attachment to a single point and to make it difficult for the attachment to move away from that point during use. The configurations of the loops in FIGS. 6 and 7 are configured similarly configured to preferentially bias an attachment to, or away from, a location on the loop 112 so as best accommodate the needs of the user. It should be appreciated to those skilled in the art that the configurations of the loop 112 at the proximal end of the device 100 are for illustrative purposes only and are not intended to be limiting. Accordingly, alternative configurations of the loop 112 are contemplated to be within the scope of this invention.

It should also be noted that the end of the wire 204 which is wrapped around the shank 106 may be wrapped any number of times around the shank 106. For example, in FIG. 1, the end of the wire 204 is wrapped twice around the shank 106. To affix an attachment to this device, the user would be required to rotate the attachment around the shank 106 two times before it was properly seated within the loop 112. Alternatively, the end of the wire 204 shown in FIG. 7 is wrapped once around the shank 106. Accordingly, a user using this device would be required to wrap the attachment around the shank 106 only one time prior to seating the attachment in the loop 112. The device 100 may be constructed by wrapping the end of the wire 204 around the shank 106 any number of times that the user finds efficient.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible configurations for the device described herein, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A device for affixing an attachment to a fishing line comprising:
a wire formed into a shank, a loop for affixing a fishing line formed by the distal end of said wire at the distal end of said shank; and
a loop for removeably affixing an attachment thereto formed at the proximal end of said shank, wherein said proximal end of said wire is loosely wrapped around said shank so as to permit the passage of the device to be attached between said wire and said shank.

2. The device of claim 1 wherein the gauge of said wire used to form said shank is between 19/0 and 32.

3. The device of claim 1 wherein said loop at said distal end of said shank is not formed from said wire of said shank, but is independently mounted on said shank.

4. The device of claim 1, wherein said attachment is selected from the group consisting of one or more hooks, an additional length of fishing line, a lure, a weight and a flotation device.

5. A device for affixing an attachment to a fishing line comprising:
an opening at the distal end of a shank for affixing a fishing line; and
an opening at the proximal end of said shank for removeably affixing an attachment, wherein said opening is formed by a reverse bend in the wire used to make said shank and the end of said wire is loosely wrapped around said shank.

6. The device of claim 5 wherein the gauge of said wire used to form said shank is between 19/0 and 32.

7. The device of claim 5 wherein said opening at said distal end of said shank is not formed from said wire of said shank, but is independently mounted on said shank.

8. The device of claim 5, wherein said attachment is selected from the group consisting of one or more hooks, an additional length of fishing line, a lure, a weight and a flotation device.

9. A device for affixing an attachment to a fishing line comprising:
a wire with a distal end and a proximal end;
forming the distal end of said wire into a loop for affixing a fishing line; and
forming the proximal end of said wire into a loop for removeably affixing an attachment by bending said wire distally and wrapping said proximal end of said wire loosely around said shank so as to permit the passage of a device to be placed in said loop to pass between said proximal end of said wire and said shank.

10. The device of claim 9 wherein the gauge of said wire used to form said shank is between 19/0 and 32.

11. The device of claim 9, wherein said attachment is selected from the group consisting of one or more hooks, an additional length of fishing line, a lure, a weight and a flotation device.

12. A device for affixing an attachment to a fishing line comprising:
a shank with a distal end and a proximal end;
means for attaching a fishing line at said distal end; and
means for attaching an attachment at said proximal end, wherein said means for attaching an attachment is formed by a reverse bend in the wire used to make said means for attaching an attachment and the end of said wire is loosely wrapped around said shank.

13. The device of claim 12 wherein the gauge of said wire wrapped around said shank is between 19/0 and 32.

14. The device of claim 12 wherein said means for attaching a fishing line at said distal end is not formed from said wire used to make said means for attaching an attachment, but is independently mounted on said shank.

15. The device of claim 12, wherein said attachment is selected from the group consisting of one or more hooks, an additional length of fishing line, a lure, a weight and a flotation device.

16. A method of affixing an attachment to a line comprising;
affixing the distal end of a device to a fishing line; and
removeably affixing an attachment to a loop at the proximal end of said device by placing the proximal end of the wire used to make said loop through the eye of said attachment and rotating said attachment until said attachment is positioned in said loop.

17. The method of claim 16 wherein the gauge of said wire is between 19/0 and 32.

18. The method of claim 16, wherein said attachment is selected from the group consisting of one or more hooks, an additional length of fishing line, a lure, a weight and a flotation device.
